(19) United States
(12) Patent Application Publication
(10) Pub. No.: US 2020/0406863 A1
(43) Pub. Date: Dec. 31, 2020

(54) A WINDSCREEN WIPER DEVICE

(71) Applicant: FEDERAL-MOGUL S.A., Aubange (BE)

(72) Inventor: Xavier Boland, Arlon (BE)

(21) Appl. No.: 16/978,018

(22) PCT Filed: Mar. 5, 2018
(86) PCT No.: PCT/EP2018/055362

§ 371 Date: Sep. 3, 2020

(51) Int. Cl. B60S 1/40; B60S 1/38

(52) U.S. Cl. CPC B60S 1/4038; B60S 2001/4058; B60S 1/3849

(57) ABSTRACT

A windscreen wiper device of the flat blade type comprising an elastic, elongated carrier element, and an elongated wiper blade of a flexible material, which can be placed in abutment with a windscreen to be wiped. The wiper blade includes at least one groove, in which a longitudinal strip of the carrier element is disposed. The windscreen wiper device also comprises a connecting device for an oscillating arm. The oscillating arm can be pivotally connected to the connecting device about a pivot axis near a free end thereof. A joint part is interposed between the oscillating arm and the connecting device. The windscreen wiper device further comprises a cover arranged to enclose the free end of the oscillating arm. The cover is slidable relative to the joint part between a first position, where the free end is retained onto the cover, and a second position, where the joint part is released from the cover. The joint part and the cover comprise mutually cooperating locking means arranged for locking the joint part relative to the cover in the first position and for unlocking the joint part relative to the cover in the second position.

### BACKGROUND OF THE INVENTION

A windscreen wiper device of the “flat blade type” is generally known. In such a windscreen wiper device, no use is made of several yokes pivotally connected to each other. Instead, the wiper blade is biased by the carrier element, as a result of which it exhibits a specific curvature. In practice, due to high forces exerted on the connection between the connecting device and the oscillating arm, the reliability of the connection appears to diminish in time. Therefore, there is a need to improve the connection on the one hand, but to ensure an easy disconnection on the other hand, particularly in case of repair or replacement of the wiper blade.

### SUMMARY OF THE INVENTION

The present invention relates to a windscreen wiper device of the flat blade type comprising an elastic, elongated carrier element, and an elongated wiper blade of a flexible material, which can be placed in abutment with a windscreen to be wiped. The wiper blade includes at least one groove in which a longitudinal strip of the carrier element is disposed. The windscreen wiper device comprises a connecting device for an oscillating arm. The oscillating arm can be pivotally connected to the connecting device about a pivot axis near a free end thereof. A joint part is interposed between the oscillating arm and the connecting device.

In the framework of the present invention the following is noted. The connecting device, also called “connector,” is preferably made of plastic. The connector is preferably made in one piece, also called a “one piece connector.” Also the joint part, also called a “spacer,” is preferably made of plastic. The joint part acts as a spacer interposed between the connecting device and the oscillating arm. The wiper blade is preferably made of an elastomeric material, such as rubber, and is preferably made through extrusion. Preferably, the wiper blade comprises a spoiler at a side thereof facing away from the windscreen to be wiped. The wiper blade and the spoiler are preferably made in one piece. The longitudinal groove is preferably a central longitudinal groove accommodating the longitudinal strip. The longitudinal strip is also called a “flexor.” The connecting device is preferably fixedly connected to the longitudinal strip(s) particularly through a welding, brazing (“soldering”), gluing or clamping operation or with the help of a pin inserted through the connecting device and the longitudinal strip(s). In the alternative or in addition thereto, the connecting device is clamped onto the flexible material of the wiper blade, particularly in case the latter is equipped with a central longitudinal groove for the carrier element. Preferably, the connecting device and the joint part are provided with mutually cooperating pivot means for pivotally connecting the joint part to the connecting device. All the above preferred features of the present invention can be used alone or in combination with any other feature(s), as a skilled person would appreciate.

An object of the invention is to provide an improved windscreen wiper device of the “flat blade type.” In order to accomplish that objective, the windscreen wiper device comprises a cover arranged to enclose the free end of the oscillating arm. The cover is slidable relative to the free end between a first position, where the joint part is retained onto the cover, and a second position, where the joint part is released from the cover. The joint part and the cover comprise mutually cooperating locking means arranged for locking the joint part relative to the cover in the first position and for unlocking the joint part relative to the cover in the second position. The cover is slidable relative to the joint part between the first and the second positions irrespective of a certain angle between the wiper blade and the oscillating arm. In other words, in a wiping position, where the wiper blade is able to carry out its oscillatory movement on a windscreen to be wiped, the oscillating arm and the unit consisting of the joint part, the connecting device and the wiper blade, are firmly interconnected. However, irrespective of a certain angle between the wiper blade and the oscillating arm, i.e. in the wiping position and in a service position, where the oscillating arm is in an upright position relative to a windscreen to be wiped, and in any position between the wiping position and the service position, the unit consisting of the joint part, the connecting device and the wiper blade can be easily disconnected for repair or replacement. Thus, the locking means do not serve as a rotation lock, so that unlocking the joint part relative to the cover may now take place at any angle between the wiper blade and the oscillating arm by hand, using some force, without any additional tools. The force preferably is chosen between 10 and 30 N.

It is noted that the present invention is not restricted to cars, but also refers to rail coaches and other (fast) vehicles.

It is noted that the present invention is not restricted to the use of only one longitudinal strip forming the elastic carrier element that is particularly located in a central longitudinal groove of the wiper blade. Instead, the carrier element may also comprise two longitudinal strips, where the strips are disposed in opposite longitudinal grooves of the wiper blade. The groove(s) may be closed at one outer end.

Further, it is noted that in the invention, use is made of a mounting head fixed for rotation to a shaft, where the shaft is rotatable alternately in a clockwise and in a counter-clockwise sense carrying the mounting head into rotation. Thus, in turn the mounting head draws the connecting device into rotation and thereby moves the wiper blade. In the alternative, the mounting head is fixed for translation to a carriage, where the carriage can be translated alternately in one linear direction and in another counter linear direction carrying the mounting head into translation. The present invention can therefore be used for circular or linear movement of the mounting head.

In one preferred embodiment of a windscreen wiper device in accordance with the invention, the cover is slidable in opposite directions along a length of the wiper blade. Hence, the cover can be slid back and forth in the longitudinal direction of the wiper blade.

In another preferred embodiment of a windscreen wiper device according to the invention the mutually cooperating locking means comprise a part of the joint part being elastically deformable. Particularly, the part of the joint part is elastically deformed upon locking and unlocking the joint part relative to the cover.

In another preferred embodiment of a windscreen wiper device in accordance with the invention, the joint part comprises opposite sidewalls each comprising a laterally outwardly extending protrusion being elastically deformable.

In another preferred embodiment of a windscreen wiper device according to the invention the cover has an at least substantially U-shaped cross-section with a base and legs, where each leg along at least a part of its length comprises an inwardly bend edge. Each protrusion is allowed to elastically deform inside or outside a recess in the bend edge in a corresponding leg of the U-shaped cross-section upon locking and unlocking the joint part relative to the cover. Preferably, the recess is formed by an interruption in the bend edge, so that in that case each leg is provided with bend edges along two, spaced apart parts of its length. When the cover is slid over the joint part, the protrusions bend downwardly until the protrusions are allowed to subsequently bend upwardly and snap inside the recesses. In the first position of the cover, the bend edges of the cover cooperate with laterally outwardly extending protuberances on either side of the joint part to lock the latter in a vertical direction relative to the cover.

In another preferred embodiment of a windscreen wiper device in accordance with the invention, the joint part is made of one piece of plastic. Preferably, the cover is made of one piece of plastic.

In another preferred embodiment of a windscreen wiper device according to the invention, the joint part comprises an upwardly and outwardly extending protrusion arranged to engage into a correspondingly shaped hole of the oscillating arm to lock the joint part relative to the cover in a longitudinal direction towards the free end of the oscillating arm. Preferably, the oscillating arm near the free end thereof has an at least substantially U-shaped cross-section with a base and legs, where the hole is provided inside the base of the U-shaped cross-section.

### BRIEF DESCRIPTION OF THE DRAWINGS

The invention will now be explained in more detail with reference to figures illustrated in a drawing, wherein:

FIG. 1 is a schematic, perspective view of a windscreen wiper device of the flat blade type according to the invention;

FIG. 2 is a schematic, perspective view of the windscreen wiper device of FIG. 1 without an oscillating arm;

FIG. 3 is a schematic, perspective view of the windscreen wiper device of FIG. 1 before the oscillating arm is mounted onto the connecting device and joint part;

FIG. 4 is an enlarged schematic, perspective view of portion “A” of the windscreen wiper device of FIG. 3;

FIG. 5 is a schematic, perspective view of the windscreen wiper device of FIG. 3 after the oscillating arm is placed on the connecting device and joint part;

FIG. 6 is a schematic, perspective view of the windscreen wiper device of FIG. 4 after the oscillating arm is locked onto the connecting device and joint part;

FIG. 7 is a cross-sectional end view of the windscreen wiper device of FIG. 5;

FIG. 8 is a cross-sectional bottom view of the windscreen wiper device of FIG. 5;

FIG. 9 is a bottom view of the windscreen wiper device of FIG. 5;

FIG. 10 is a cross-sectional end view of the windscreen wiper device of FIG. 6;

FIG. 11 is a cross-sectional bottom view of the windscreen wiper device of FIG. 6; and

FIG. 12 is a bottom view of the windscreen wiper device of FIG. 6.

### DETAILED DESCRIPTION OF PREFERRED EMBODIMENTS

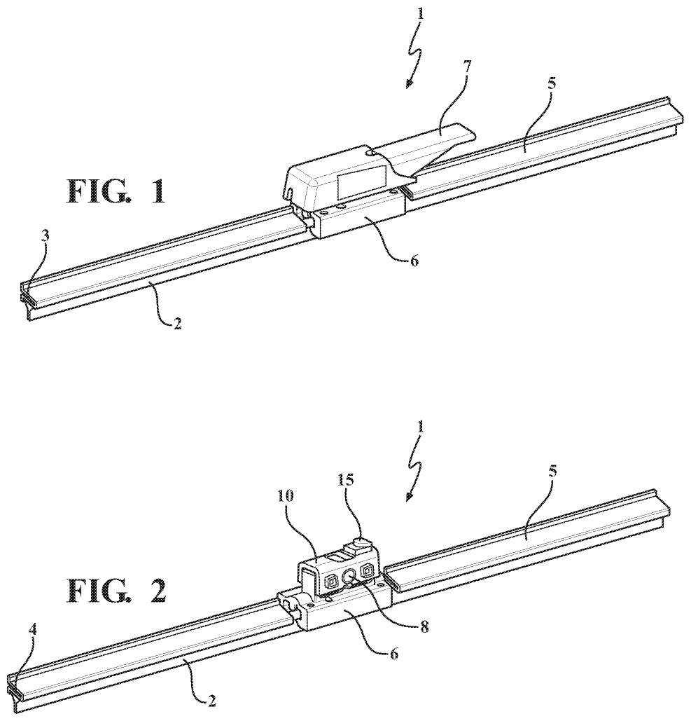

FIGS. 1-2 show a windscreen wiper device 1 of the “flat blade” type according to the invention. The windscreen wiper device 1 includes an elastomeric wiper blade 2 having a central longitudinal groove 3 formed therein. The windscreen wiper device 1 also includes a central longitudinal strip 4 made of spring band steel disposed within the longitudinal groove 3. The strip 4 forms a flexible carrier element for the rubber wiper blade 2, which is thus biased in a curved position (the curvature in operative position being that of a windscreen to be wiped). Neighbouring ends of the strip 4 are left free. In the alternative, these neighbouring ends are connected on either side of the windscreen wiper device 1 to connecting pieces or “end caps” (not shown) functioning as clamping members. These connecting pieces may be separate constructional elements, which may be form-locked (“positive locking” or “having positive fit”), as well as force-locked to the ends of the strip 4. In another preferred variant, the connecting pieces are in one piece with the strip 4 made of spring band steel. Possibly, a spoiler 5 is furthermore provided.

With reference to FIGS. 1-6, the windscreen wiper device 1 also includes a connecting device 6 preferably of plastic material for an oscillating wiper arm 7. The connecting device 6 comprises two cylindrical protrusions 8 extending outwards on either side thereof, i.e. on each vertical side wall thereof. These protrusions 8 pivotally engage in identically shaped cylindrical, co-axial holes 9 of a joint part or spacer 10 preferably of plastic material. The protrusions 8 act as bearing surfaces at the location of a pivot axis in order to pivot the joint part 10 (and the oscillating wiper arm 7 attached thereto) about the pivot axis near a free end of the oscillating wiper arm 7. The protrusions 8 are preferably in one piece with the connecting device 6. In the alternative, the protrusions 8 are part of a single pivot pin perpendicular to the connecting device 6. The connecting device 6 is connected to the elastomeric material of the wiper blade 2. This connecting device 6 has a more or less U-shaped cross-section with legs 11. Free ends of the legs 11 of the U-shaped cross-section extend inwardly so as to form grooves or slits 12 for receiving longitudinal sides of the wiper blade 2. The free ends and parallel walls 13 of the connecting device 6 are provided with holes 14 for receiving pins (not shown) exerting a controllable, predetermined pressure on the rubber material of the wiper blade 2. Thus, any lateral movement between the longitudinal strip 4 and the wiper blade 2 at the location of their interconnection and between the connecting device 6 and the wiper blade 2 at the location of their interconnection is blocked. In use, during each oscillatory movement of the oscillatory arm, the wiper blade 2 at the location outside the connection device 6 would normally suffer from a so-called “fishtailing phenomenon,” where the wiper blade 2 on opposite sides of the connecting device 6 vibrates in an uncontrollable manner parallel to a windscreen to be wiped. Obviously, this “fishtailing phenomenon” results in deteriorated wiping properties, with all negative consequences involved, particularly at high speeds. Hence, the longitudinal strip 4 is allowed to exhibit a curvature at the location of the interconnection of the connecting device 6 and the wiper blade 2. Experimental results have shown that the “fishtailing phenomenon” is avoided at least to a large extent.

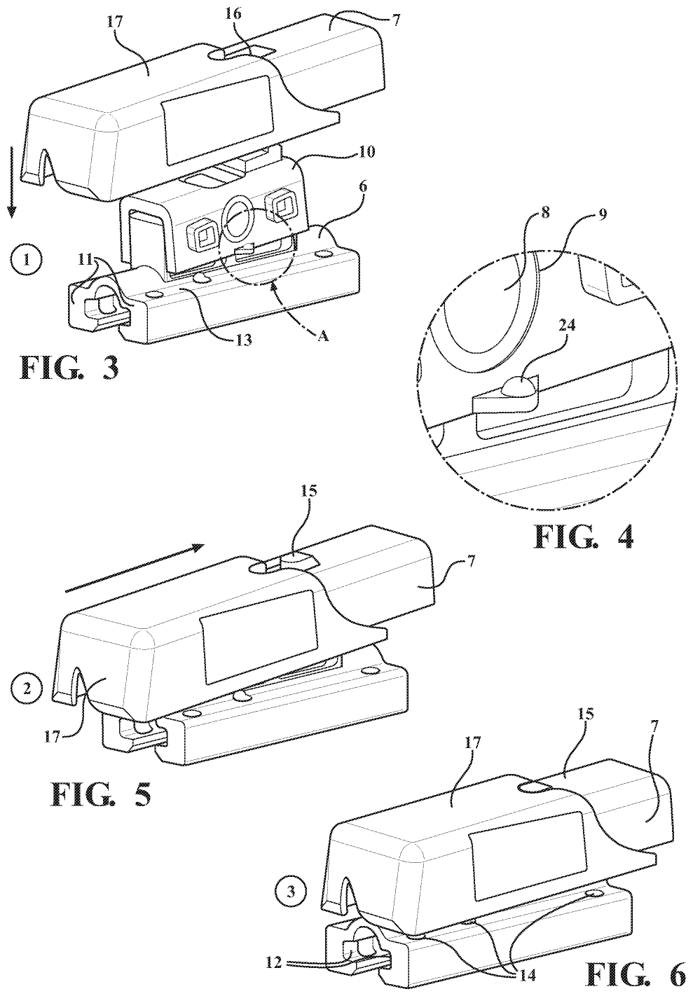

Again referring to FIGS. 1-6, the joint part 10 comprises a protrusion 15 extending upwardly and outwardly, while the oscillating arm 7 has a U-shaped cross-section at the location of its connection to the joint part 10, so that the protrusion 15 engages in an identically shaped hole 16 provided in a base of the U-shaped cross-section. The connecting device 6 with the wiper blade 2 is mounted onto the oscillating arm as follows. Referring to FIG. 3, the free end (or “arm extremity”) of the oscillating arm 7 is lowered in the direction of the arrow onto the joint part 10 connected to the connecting device 6 until the protrusion 15 on the joint part 10 rests inside the hole 16 of the oscillating arm 7. A cover 17, as explained hereunder, is then slid in the direction of the arrow in FIG. 5 to lock the joint part 10 in place.

Referring to FIGS. 3, 5 and 6 showing subsequent steps 1, 2 and 3 for mounting a unit consisting of the wiper blade 2, the connecting device 6 and the joint part 10 to the oscillating arm 7, the windscreen wiper device 1 comprises the cover 17 arranged to enclose the free end of the oscillating arm 7. The cover 17 is preferably a separate constructional element (i.e. not in one piece with the oscillating arm 7) and is preferably made of plastic material. First, as shown in FIG. 3, the joint part 10 is placed inside the U-shaped oscillating arm 7 from below (step 1). Subsequently, during the same sliding movement in the direction of the arrow in step 2 of FIG. 5, as mentioned above, the cover 17 is slid to be locked onto the joint part 10 (step 2). Finally, referring to FIG. 6, the cover 17 is locked through a snapping operation (step 3).

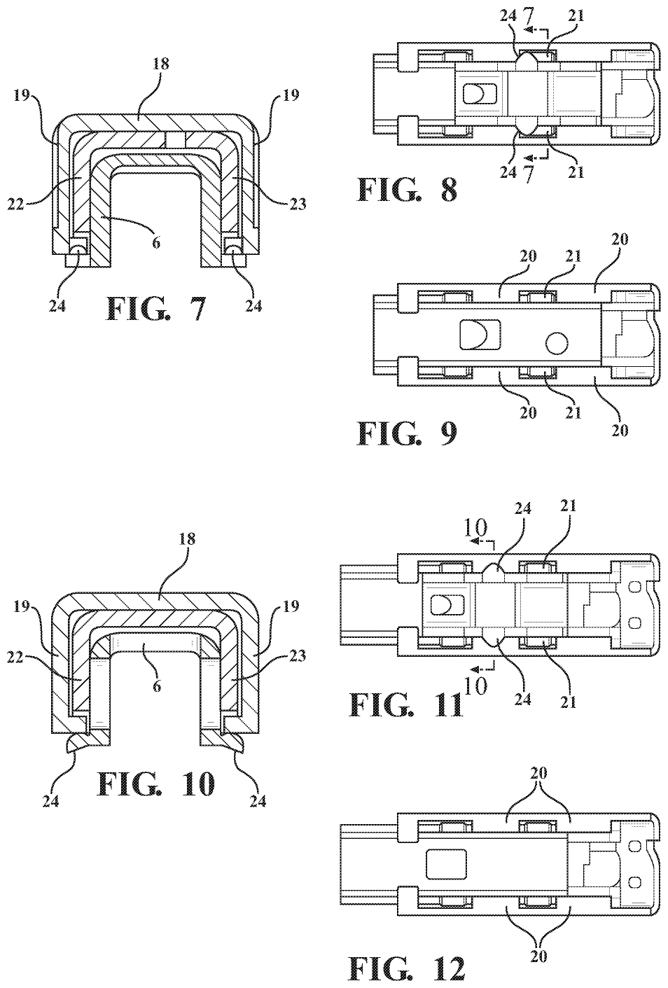

FIGS. 7-12 show in detail how the cover 17 and the joint part 10 are interconnected through a snapping operation by a relative sliding movement in longitudinal direction of the wiper blade 2. As shown in FIGS. 7 and 10, the cover 17 has a U-shaped cross-section with a base 18 and legs 19. As shown in FIGS. 9 and 12, each leg 19 along its length comprises an inwardly bend edge 20, and the bend edge 20 of each leg 19 is interrupted by a recess 21. As shown in FIGS. 7 and 10, the joint part 10 comprises opposite sidewalls 22,23 each comprising a laterally outwardly extending protrusion 24 (FIG. 4) being elastically deformable. Each protrusion 24 is allowed to elastically deform inside (FIGS. 7-9 in a locking position) or outside (FIGS. 10-12 in an unlocking position) the recess 21 in the bend edge 20 in a corresponding leg 19 of the U-shaped cross-section of the cover 17 upon locking (FIGS. 7-9) and unlocking (FIGS. 10-12) the joint part 10 relative to the cover 17, i.e. by a relative sliding movement in the direction of the arrow in step 2 of FIG. 5.

The invention is not restricted to the variants shown in the drawing, but it also extends to other preferred embodiments that fall within the scope of the appended claims.

1. A windscreen wiper device of the flat blade type including an elastic, elongated carrier element and an elongated wiper blade of a flexible material, adapted to be placed in abutment with a windscreen to be wiped, wherein the wiper blade includes at least one groove in which a longitudinal strip of the carrier element is disposed, wherein the windscreen wiper device comprises:
a connecting device;
a joint part detachably and pivotally connected to said connecting device about a pivot axis;
an oscillating arm; and
a cover arranged to enclose a free end of said oscillating arm, wherein said cover is slidable relative to said free end between a first position, wherein said joint part is retained onto said cover, and a second position, wherein said joint part is released from said cover, wherein said joint part and said cover comprise mutually cooperating locking means arranged for locking said joint part relative to said cover in said first position and for unlocking said joint part relative to said cover in said second position.

2. The windscreen wiper device according to claim 1, wherein said cover is slidable in opposite directions along a length of the wiper blade.

3. The windscreen wiper device according to claim 1, wherein said mutually cooperating locking means comprise a part of said joint part being elastically deformable.

4. The windscreen wiper device according to claim 3, wherein said part of said joint part is elastically deformed upon locking and unlocking said joint part relative to said cover.

5. The windscreen wiper device according to claim 3, wherein said joint part comprises opposite sidewalls each comprising a laterally outwardly extending protrusion being elastically deformable.

6. The windscreen wiper device according to claim 5, wherein said cover has an at least substantially U-shaped cross-section with a base and legs, wherein each leg along at least a part of its length comprises an inwardly bend edge, and wherein each protrusion is allowed to elastically deform inside or outside a recess in said bend edge in a corresponding leg of said U-shaped cross-section upon locking and unlocking said joint part relative to said cover.

7. The windscreen wiper device according to claim 1, wherein said joint part comprises one piece of plastic.

8. The windscreen wiper device according to claim 1, wherein said cover comprises one piece of plastic.

9. The windscreen wiper device according to claim 1, wherein said joint part comprises an upwardly and outwardly extending protrusion arranged to engage into a correspondingly shaped hole of said oscillating arm to lock said joint part relative to said cover in a longitudinal direction towards said free end of said oscillating arm.

10. The windscreen wiper device according to claim 9, wherein said oscillating arm near said free end thereof has an at least substantially U-shaped cross-section with a base and legs, and wherein said hole is provided inside said base of said U-shaped cross-section.
